(19) United States
(12) Patent Application Publication
(10) Pub. No.: US 2025/0383950 A1
(43) Pub. Date: Dec. 18, 2025

(54) MULTI-RATE PROCESS FAULT DETECTION METHOD BASED ON TOTAL AUTOREGRESSIVE DYNAMIC LATENT VARIABLE MODELS

(71) Applicant: ZHEJIANG UNIVERSITY OF SCIENCE & TECHNOLOGY, Hangzhou (CN)

(72) Inventors: Le ZHOU, Hangzhou (CN); Donglei ZHENG, Hangzhou (CN); Beiping HOU, Hangzhou (CN); Hongbo ZHENG, Hangzhou (CN); Yaoxin WANG, Hangzhou (CN)

(21) Appl. No.: 18/559,918

(22) PCT Filed: Apr. 17, 2023
(86) PCT No.: PCT/CN2023/088691

§ 371 Date: Aug. 27, 2025

(30) Foreign Application Priority Data
Feb. 6, 2023 (CN) 202310063661.8

(51) Int. Cl. G06F 11/07

(52) U.S. Cl. CPC G06F 11/079; G06F 11/0736

(57) ABSTRACT

The present invention discloses a multi-rate process fault detection method based on a Total Auto-regressive Dynamic Latent Variable Model. The multi-rate data samples of the process are collected online. The method utilizes a Total Multi-rate Auto-regressive Dynamic Latent Variable Model (TMrARDLV) to obtain the dynamic T² statistics of the current moment test samples, static T² statistics for each sampling rate, and SPE statistics. These statistics are then compared with the pre-established detection control limits to determine the online detection results of the process. This method fully utilizes comprehensive multi-rate data information from the process. It also considers the dynamic and static characteristics of the data separately by employing Kalman filtering and Bayesian methods. Moreover, it achieves accurate estimation of dynamic and static latent variables. The dynamic and static latent variables obtained through dimensionality reduction respond to faults in different data subspaces. This method enhances the accuracy and applicability of fault detection.

### FIELD OF THE INVENTION

This invention generally relates to control methods, and more specifically related to a fault detection method based on the Total Multi-rate Autoregressive Dynamic Latent Variable Model.

### BACKGROUND OF THE INVENTION

With the development of modern industrial processes, the scale and complexity of industrial production have gradually increased. Timely detection of potential faults in large-scale industrial processes has gained widespread attention. With the widespread application of Distributed Control Systems (DCS) in the industrial sector, a large number of production process variables are stored in the system database at relatively high sampling rates, while some intermediate variables in the scheduling layer and key quality variables that require offline testing have lower sampling rates. This situation results in the presence of multi-rate characteristics in complex industrial process data. With the advancement of multivariate statistical process monitoring (MSPM) techniques, massive process data is reduced, reconstructed, and visualized in real-time for monitoring the production process. These techniques are extensively applied in fields such as chemical engineering, metallurgy, and pollution control. Traditional static process monitoring models such as Principal Component Analysis (PCA) and Partial Least Squares (PLS) perform poorly when dealing with high-dimensional time-series correlated process data. While most dynamic process monitoring models, like Dynamic PCA (DPCA), Canonical Variate Analysis (CVA), and Linear Gaussian State Space Models (LGSSM), describe the temporal correlations of processes, they do not consider the multi-rate characteristics of process data. Multi-rate Dynamic Latent Variable Model can fully utilize multiple sampling information in process data and estimate model parameters by the Expectation-Maximization (EM) algorithm. However, these dynamic models assume that dynamic latent variables also contain the static characteristics of the process, leading to compromised performance in detecting faults in strongly coupled complex industrial processes. Therefore, there is a need to propose an industrial process fault detection method that can utilize multi-rate process data and consider both dynamic and static characteristics of the process separately.

### BRIEF SUMMARY OF THE INVENTION

The purpose of the present invention is to address the shortcomings in existing technologies by providing a multi-rate industrial process fault detection method based on a Total Auto-regressive Dynamic Latent Variable Model.

a multi-rate industrial process fault detection method based on a Total Auto-regressive Dynamic Latent Variable Model including: collecting multi-rate data samples from chemical processes online, obtaining a test sample set, standardizing the test sample set, utilizing a pre-constructed Total Multi-rate Auto-regressive Dynamic Latent Variable model (TMrARDLV) to calculate the dynamic T² statistic, static T² statistics for each sampling rate, and SPE statistic for the current moment of the test sample, comparing them with pre-determined detection control limits to derive the online detection results for chemical processes. In the TMrARDLV, there exists a linear relationship between the multi-rate data samples and the dynamic latent variables as well as the static latent variables for each sampling rate.

During the training of the TMrARDLV, samples of variables corresponding to various sampling rates under normal operating conditions of the respective processes (such as the papermaking wastewater treatment process) are collected. These samples are compiled into a training dataset used for modeling, which is then standardized before being utilized for the construction of the TMrARDLV. The term “different sampling rates” refers to the use of varying sampling rates for data collection. In this invention, the samples of multiple variables are collected at potentially completely different sampling rates, although partial similarities in sampling rates might also exist.

As one embodiment, the structure of the TMrARDLV is as follows:

$$\{ \begin{matrix}x ( k ) & = Az ( k - 1 ) + v ( k ) \\ {y}^{ξ} ( k ) & = {C}^{ξ} ( k ) x ( k ) + {Ψ}^{ξ} ( k ) {t}^{ξ} ( k ) + {w}^{ξ} ( k )\end{matrix}$$

wherein: x(k) represents the dynamic latent variables of the model at moment k; z(k−1) contains the dynamic latent variables of the model at the past L moments, L is the lag time; A represents the state transition matrix of the dynamic latent variables of the model; v(k) represents the dynamic noise of the model at moment k; y^{ξ}(k) represents the variables collected at moment k; C^{ξ}(k) represents the dynamic divergence matrix between the variables collected at the moment k and the dynamic latent variables.; t^{ξ}(k) represents the static latent variables corresponding to the variables collected at moment k, Ψ^{ξ}(k) represents the static divergence matrix between the variables collected at moment k and the corresponding static latent variables.; w^{ξ}(k) represents the measurement noise of the variables collected at moment k; ξ represents the attributes of the samples collected at the current moment.

To facilitate the handling of multi-rate data and the intuitive representation of subsequent formulas, sampling coefficients λ are introduced during both model training and practical usage. The representation of these sampling coefficients is as follows:

$$λ = [ \begin{matrix}{λ}_{11} & {λ}_{12} & ⋯ & {λ}_{1 M} \\ {λ}_{21} & {λ}_{22} & ⋯ & {λ}_{2 M} \\ ⋮ & ⋮ & ⋱ & ⋮ \\ {λ}_{K 1} & {λ}_{K 2} & ⋯ & {λ}_{KM}\end{matrix} ]$$

$${λ}_{km} = \{ \begin{matrix}1 , & If the variable at m - th rate acquired at k \\ 0 , & If the variable at m - th rate not acquired at k\end{matrix}$$

In the model structure of the TMrARDLV: y^{ξ}(k), C^{ξ}(k), t^{ξ}(k), Ψ^{ξ}(k), w^{ξ}(k) are all dependent on the sampling coefficient λ, specifically:

The value of y^{ξ}(k) comes from {y₁, y₂, . . . yₘ, . . . y_{M}}, and its composition is determined by sampling coefficients, yₘ represents the sample set of variables at m-th sampling rate.

The value of C^{ξ}(k) comes from {C₁, C₂, . . . , Cₘ, . . . , C_{M}}, and its composition is determined by sampling coefficients, Cₘ represents the dynamic divergence matrix between variables and dynamic latent variables at m-th sampling rate.

The value of t^{ξ}(k) comes from {t₁, t₂, . . . tₘ, . . . t_{M}}, and its composition is determined by sampling coefficients, tₘ represents the unique static latent variable specific to variables at m-th sampling rate.

The value of Ψ^{ξ}(k) comes from {Ψ₁, Ψ₂, . . . Ψₘ, . . . Ψ_{M}}, and its composition is determined by sampling coefficients, Ψₘ represents the static divergence matrix for the m-th sampling rate.

The value of w^{ξ}(k) comes from {w₁, w₂, . . . wₘ, . . . w_{M}} and its composition is determined by sampling coefficients, wₘ represents the measurement noise of variables at m-th sampling rate, which follows the Gaussian distribution wₘ˜N(0,Rₘ).

The specific representation of y^{ξ}(k)=C^{ξ}(k)x(k)+Ψ^{ξ}(k)t^{ξ}(k)+w^{ξ}(k) at a certain moment is determined by the sampling coefficient at that moment. Suppose at moment k, variables under E different sampling rates are collected, then the sampling coefficient λ corresponding to the samples under E different sampling rates is λ=1. E different sampling rates are m₁, m₂, . . . , mᵢ . . . , m_{E}, derived from M sampling rates and determined by the sampling coefficients. At this moment, the expression of y^{ξ}(k)=C^{ξ}(k)x(k)+Ψ^{ξ}(k)t^{ξ}(k)+w^{ξ}(k) is as follows:

$${y}_{{m}_{1}} ( k ) = {C}_{{m}_{1}} ( k ) x ( k ) + {Ψ}_{{m}_{1}} ( k ) {t}_{{m}_{1}} ( k ) + {w}_{{m}_{1}} ( k )$$

$${y}_{{m}_{2}} ( k ) = {C}_{{m}_{2}} ( k ) x ( k ) + {Ψ}_{{m}_{2}} ( k ) {t}_{{m}_{2}} ( k ) + {w}_{{m}_{2}} ( k )$$

$$⋮$$

$${y}_{{m}_{i}} ( k ) = {C}_{{m}_{i}} ( k ) x ( k ) + {Ψ}_{{m}_{i}} ( k ) {t}_{{m}_{i}} ( k ) + {w}_{{m}_{i}} ( k )$$

$$⋮$$

$${y}_{{m}_{E}} ( k ) = {C}_{{m}_{E}} ( k ) x ( k ) + {Ψ}_{{m}_{E}} ( k ) {t}_{{m}_{E}} ( k ) + {w}_{{m}_{E}} ( k )$$

wherein: yₘ_{ᵢ}(k) represents the variables at sampling rate mᵢ collected at moment k, Cₘ_{ᵢ}(k) represents the dynamic divergence matrix between the variables at sampling rate mᵢ collected at the moment k and the dynamic latent variables. tₘ_{ᵢ}(k) represents the unique static latent variables at sampling rate mᵢ at moment k. Ψₘ_{ᵢ}(k) represents the static divergence matrix at sampling rate mᵢ at moment k. wₘ_{ᵢ}(k) represents the measurement noise at sampling rate mᵢ at moment k.

The expectation-maximization (EM) algorithm can be utilized to update the model parameters of the proposed TMrARDLV.

Specifically, during the optimization process using the EM algorithm (or when updating the model parameters using the EM algorithm), in the E-step, the posterior probabilities of dynamic latent variables are estimated using the Kalman filter algorithm combined with the current model parameters. Simultaneously, the posterior probabilities of static latent variables are estimated using the Bayesian method combined with the current model parameters. In the M-step, the model parameters of the TMrARDLV are updated by maximizing the likelihood function. This iterative process continues, alternating between the E-step and M-step, until the convergence condition of the model is met.

Alternatively, the parameters obtained after training the TMrARDLV can be used to calculate the posterior expectations of dynamic latent variables and static latent variables under different sampling rates for the training samples. The expectations and variances of the dynamic latent variables are used to construct T_{d}² statistics (dynamic T² statistics), while the expectations and variances of the static latent variables are used to construct Tₛ² statistics (static T² statistics). SPE statistics are constructed based on the model's reconstruction errors.

T_{d_lim}², the control limit of T_{d}², is obtained from χ² distribution. The estimation method for control limits is as follows:

$${T}_{d , lim}^{2} = {χ}_{α}^{2} ( D )$$

where D is the dimension of the dynamic latent variables.

The estimation method for T_{s_lim}², the control limit of Tₛ², is as follows: Tₛ²˜g·χₕ², which means that Tₛ² follows χ² distribution, wherein:

$$gh = mean ( {T}_{s}^{2} )$$

$$2 {g}^{2} h = var ( {T}_{s}^{2} )$$

wherein mean (●) represents mean calculation, var (●) represents variance calculation, χₕ² represents chi-square distribution, g and h represent the coefficients and degrees of freedom of the chi-square distribution, respectively; by using the above equation, g and h can be obtained, and then the control limits for the Tₛ² statistic can be calculated.

The estimation method for SPEₗᵢₘ, the control limit of SPE, is as follows: SPE˜g·χₕ², which means that SPE follows χ² distribution, wherein:

$$gh = mean ( SPE )$$

$${g}^{2} h = var ( SPE )$$

wherein mean (●) represents mean calculation, var (●) represents variance calculation, χₕ² represents chi-square distribution, g and h represent the coefficients and degrees of freedom of the chi-square distribution, respectively; by using the above equation, g and h can be obtained, and then the control limits for the SPE statistic can be calculated.

As a further refined approach, a multi-rate process fault detection method based on a Total Auto-regressive Dynamic Latent Variable Model is proposed, comprising:

(I) For multi-rate processes, a TMrARDLV is trained using a multi-rate training sample set, and the detection control limits are obtained.

(II) New multi-rate process sample data corresponding to process variables and key quality variables in the training sample set are collected online to form a test sample set.

(III) The obtained test sample set is standardized using the same manner.

(IV) For the standardized test sample set, T_{d}² statistics (dynamic T² statistics), Tₛ² statistics (static T² statistics for various sampling rates), and SPE statistics for the current moment are obtained using the trained TMrARDLV. By comparing with the detection control limits, online detection results of the process are obtained.

A more specific approach involves a multi-rate process fault detection method based on a Total Auto-regressive Dynamic Latent Variable Model, comprising:

(1) Collect various variable samples at different sampling rates under normal operating conditions during the process to form a training sample set for modeling.

(2) Standardize the obtained training sample set to establish a linear correlation between the standardized variable values and latent variables.

(3) Construct a TMrARDLV based on the preprocessed training sample set.

(4) Based on the established TMrARDLV, obtain the corresponding detection control limits for the T_{d}², Tₛ², and SPE statistics of the training samples.

(5) Collect new multi-rate process sample data corresponding to process variables and key quality variables in the training sample set during the online process to form a test sample set.

(6) Standardize the obtained test sample set using the procedure outlined in step (2).

(7) Utilize the TMrARDLV obtained in step (4) to calculate the T_{d}², Tₛ², and SPE statistics for the current moment of the test samples. Compare these statistics with the detection control limits obtained in step (4) to determine the online detection results of the process.

The variable samples used for modeling and monitoring include, but are not limited to, one or more of the following types of data: (1) variables at the equipment level detected by distributed control systems (such as current, voltage, power, displacement, rotation speed, etc., with sampling frequencies typically ranging from milliseconds to seconds); variables at the process level (such as temperature, pressure, flow rate, liquid level, pH value, etc., with sampling frequencies typically ranging from minutes to hours). These variables are also known as process variables; (2) key quality variables that are difficult to measure under normal operating conditions and are obtained by analytical methods (including variables representing product yield and quality, such as target substance concentration, etc., with sampling frequencies typically ranging from hours to days). These data are known as key quality variables; (3) indicator-level data that need to be statistically calculated (data representing operating economic indicators, energy consumption indicators, etc., with sampling frequencies possibly ranging from weeks to months).

The process variable samples are collected using distributed control systems, and the key quality variable samples are collected using analytical methods. In this invention, process variable samples generally refer to variables that can be detected by existing sensors, which can be conveniently collected through distributed control systems, such as temperature, pressure, flow rate, etc. The key quality variables generally cannot be or are difficult or inappropriate to be directly detected by existing sensors, such as the concentration of certain intermediates or raw materials. As one embodiment, this invention mainly uses process variable samples or a combination of process variable samples and key quality variable samples for model construction, etc.

The process variable samples are collected using distributed control systems, while the key quality variable samples are obtained through laboratory methods. The laboratory methods in this invention include but are not limited to chemical titration, strip tests, purity analysis (such as detection methods involving HPLC, LC-Ms, etc.), and nuclear magnetic resonance tests, among others.

In this invention, process variable samples generally refer to variables that can be detected by existing sensors and can be conveniently collected through distributed control systems, such as temperature, pressure, flow rate, etc. The key quality variables, on the other hand, generally cannot be easily or directly detected by existing sensors, such as the concentration of certain intermediates or raw materials. As one implementation of the invention, the models are primarily constructed using process variable samples alone or in combination with key quality variable samples.

Assuming there are M different sampling rates in the industrial process and a total of K historical data samples are collected for model training. Within the specified sampling time period, a set of normal variable samples Y, Y={Y₁; Y₂; . . . ; Yₘ; . . . ; Y_{M}} is collected, covering M different sampling rates. Among them, the variable samples for the m-th sampling rate are denoted as Yₘ. The sample sizes for the M different sampling rate samples are K₁, K₂ . . . , K_{M} respectively:

$${Y}_{m} ∈ {R}^{{K}_{m} \times {G}_{m}} , \qquad ( 1 )$$

$${Y}_{m} = \{ {y}_{m} ( 1 ) , {y}_{m} ( 2 ) , … , {y}_{m} ( i ) , … , {y}_{m} ( {K}_{m} ) \} , m = 1 , 2 , … , M ; i = 1 , 2 , … , {K}_{m}$$

where R represents the set of real numbers. In the M variety types of process variables and quality variables, Gₘ represents the number of variables under sampling rate m, Kₘ represents the number of samples under sampling rate m; yₘ(i) represents i-th sample of the variables under sampling rate m. Store this data in the historical database to form the training sample set for modeling purposes.

During both the training process and after obtaining real-time online data, the mentioned standardization operation is necessary. Through this standardization, each element value in every process variable or key quality variable fluctuates around zero. Values greater than 0 indicate above-average levels, while values less than 0 indicate below-average levels, and they exhibit a linear correlation with the latent variables. To elaborate further, the standardization method is as follows: at a specific sampling rate, for each process variable or key quality variable at that sampling rate, each element is first subtracted by the corresponding mean value of each process variable or key quality variable. Then, the result is divided by the overall standard deviation of the variable's sample set.

The standardization method remains the same for both the modeling process and actual detection.

In the modeling process, it is possible to first construct a multi-rate dynamic model. Then, expand the constructed multi-rate dynamic model into a total multi-rate dynamic model. Finally, based on the obtained total multi-rate dynamic model, use the preprocessed training sample set to construct a TMrARDLV.

Specifically, due to the linear correlation between the standardized training dataset and latent variables, the following multi-rate dynamic latent variable model can be derived:

$$\{ \begin{matrix}x ( k ) & = Az ( k - 1 ) + v ( k ) \\ {y}^{ξ} ( k ) & = {C}^{ξ} ( k ) x ( k ) + {u}^{ξ} ( k )\end{matrix} \qquad ( 2 )$$

wherein X∈R^{D} represents the dynamic latent variables of this model with a dimensionality of D), x(k) represents the dynamic latent variables of the model at the moment k, z(k−1)=[x^{T}(k−1)x^{T}(k−2) . . . x^{T}(k−L)]^{T}∈R^{DL×1} incorporate the dynamic latent variables of this model from the past L moment steps, L is the lag time. A∈R^{D×DL} the state transition matrix for the dynamic latent variables of the model. v(k) represents the dynamic noise of the model at time k, following a Gaussian distribution v(k)˜N(0, Q). The training sample set comprises a total of M sampling rates, where the linear relationship between variables at the m-th sampling rate and dynamic latent variables is represented by the dynamic divergence matrix Cₘ. The collection of all dynamic divergence matrices is denoted as {C₁, C₂, . . . Cₘ, . . . C_{M}}. Similarly, yₘ represents the process variables at the m-th sampling rate and the collection of all process variables is denoted as {y₁, y₂, . . . yₘ, . . . y_{M}}, uₘ represents the measurement noise at the m-th sampling rate, following a Gaussian distribution uₘ˜N(0, Ωₘ), wherein Ωₘ represent the variance of measurement noise at the m-th sampling rate, and the collection of the variance is denoted as {Ω₁, Ω₂, . . . Ωₘ, . . . Ω_{M}}.

C^{ξ}(k) represents the dynamic divergence matrix for the model at moment k which can be specifically expressed as C^{ξ}(k)=[Cₖ₁^{T}, Cₖ₂^{T}, . . . , C_{kE}^{T}]^{T}. Wherein E represents the total number of sampling rates corresponding to the data contained in Y at moment k. Cₖ₁ represents the model parameters corresponding to the first collected process variables or key quality variables. Hence C^{ξ}(k) comes from {C₁, C₂, . . . Cₘ, . . . C_{M}} and depends on whether the corresponding sample is collected at that moment. Similarly, y^{ξ}(k) comes from {y₁, y₂, . . . yₘ, . . . Y_{M}}. u^{ξ}(k) represents the input noise matrix for variables at moment k in the model, which follows the following Gaussian distribution:

$${u}^{ξ} ( k ) \sim N ( 0 , {Ω}^{ξ} ( k ) ) \qquad ( 3 )$$

$${Ω}^{ξ} ( k ) = diag \{ {Ω}_{k 1} ; {Ω}_{k 2} ; … ; {Ω}_{kE} \}$$

Similarly, Ω^{ξ}(k) here comes from {Ω₁, Ω₂, . . . Ωₘ, . . . Ω_{M}}.

Moreover, based on the multi-rate dynamic latent variable model constructed above, by further decomposing the noise matrix u^{ξ}(k) at each sampling rate, the following TMrARDLV can be obtained:

$$\{ \begin{matrix}x ( k ) & = Az ( k - 1 ) + v ( k ) \\ {y}^{ξ} ( k ) & = {C}^{ξ} ( k ) x ( k ) + {Ψ}^{ξ} ( k ) {t}^{ξ} ( k ) + {w}^{ξ} ( k )\end{matrix} \qquad ( 4 )$$

Wherein, tₘ∈R^{S}^{ₘ} represents the unique static latent variables at m-th sampling rate. Sₘ represents the dimension of the unique static latent variables at m-th sampling rate, and the collection of all static latent variables for all sampling rate is denoted as {t₁, t₂, . . . tₘ, . . . t_{M}}. t^{ξ}(k)=[tₖ₁^{T}, tₖ₂^{T}, . . . , t_{kE}^{T}]^{T} represents the static variables corresponding to the multi-rate sample at moment k. t^{ξ}(k) comes from {t₁, t₂, . . . , tₘ, . . . t_{M}} and depends on whether the corresponding sample is collected at that moment. Similarly, Ψₘ represents the static divergence matrix at m-th sampling rate and its collection is {Ψ₁, Ψ₂, . . . Ψₘ, . . . Ψ_{M}}. Ψ^{ξ}(k)=diag{Ψₖ₁^{T}, Ψₖ₂^{T}, . . . Ψ_{kE}^{T}} comes from {Ψ₁, Ψ₂, . . . Ψₘ, . . . Ψ_{M}}. wₘ represents the measurement noise at the m-th sampling rate, following a Gaussian distribution wₘ˜N(0, Rₘ), Rₘ represent the variance of measurement noise at the m-th sampling rate, and the collection of the variance is denoted as {R₁, R₂, . . . Rₘ, . . . R_{M}}. Similarly:

$${w}^{ξ} ( k ) \sim N ( 0 , {R}^{ξ} ( k ) )$$

$${R}^{ξ} ( k ) = diag \{ {R}_{k 1} ; {R}_{k 2} ; … ; {R}_{kE} \}$$

where R^{ξ}(k) comes from {R₁, R₂, . . . Rₘ, . . . R_{M}}.

Collect new same variables sample as the training sample set during online papermaking wastewater treatment. The sampling interval is determined by the highest-sampling-rate process variable (which can be equal to or greater than the highest sampling rate, or even less). This process generates the test sample set, which is then standardized in the same way as during the training phase.

After obtaining the test samples, firstly, the obtained TMrARDLV and the model parameters obtained during the training phase are used to process the test samples. The Kalman filtering algorithm is employed to calculate the expected values of dynamic latent variables at the current moment of the test samples, and Bayesian methods are used to calculate the expected values of static latent variables at the current time of the test samples. The control limits for T_{d}², Tₛ², and SPE statistics are determined using the expected values of dynamic and static latent variables. The test samples are then evaluated against these control limits to determine if they exceed the limits, leading to online fault detection results for the chemical production process.

In this invention, the detection control limits for dynamic T² statistics are obtained from the chi-square distribution. The detection control limits for static T² statistics at each sampling rate and SPE statistics are obtained from the corresponding statistics from the training samples.

The invention encompasses processes including but not limited to chemical wastewater treatment processes (such as papermaking wastewater treatment processes), chemical raw material or intermediate preparation processes, refining processes for chemical raw materials or intermediates, pesticide/pharmaceutical/pharmaceutical intermediate preparation processes, and refining processes, among others.

This invention presents a multi-rate process fault detection method based on a total auto-regressive dynamic latent variables model. It utilizes process variables and quality variables at different sampling rates as modeling samples, considering the autocorrelation of multi-rate data and the cross-correlation among data at different sampling rates. The method extracts global dynamic latent variables and local static latent variables at various sampling rates. Based on this model, a corresponding fault detection method is established to address the challenges in detecting complex multi-rate process faults. The method maximizes the utilization of complete multi-rate data by considering both the dynamic and static characteristics of the data using Kalman filtering and Bayesian methods. It accurately estimates dynamic and static latent variables, and these reduced dynamic and static latent variables respond to faults in different data subspaces. The method enhances fault detection accuracy and the scope of application.

Compared to existing techniques, the beneficial effects of this invention are evident in the following aspects:

This invention's fault detection method for papermaking wastewater treatment processes based on a total dynamic latent variable model uses process variables and quality variables at different sampling rates as modeling samples. It fully utilizes complete multi-rate data, considering both the autocorrelation and cross-correlation of the data. It designs global dynamic latent variables and unique static latent variables for each sampling rate. The model parameters are estimated using the EM algorithm, Kalman filtering algorithm, and Bayesian methods. Based on this model, a corresponding fault detection method is established to solve the challenges in detecting faults in complex multi-rate coupled processes. The method processes multiple sampling rate information, utilizing data fully while considering the dynamic characteristics of data through Kalman filtering. It achieves accurate estimation of dynamic latent variables and provides better estimation and description of multi-sample critical quality variables that are difficult to measure directly. This improvement enhances fault detection accuracy and broadens the scope of application.

### FIGURE DESCRIPTION

FIG. 1 The logarithm of the likelihood function of TMrARDLV varies with the number of model training iterations in R2S process.

FIG. 2 Detection results of TMrARDLV for fault 1 in R2S process: (a) detection results of dynamic T² statistic and SPE statistic (b) detection results of static T² statistic.

FIG. 3 Detection results of TMrARDLV for fault 2 in R2S process: (a) detection results of dynamic T² statistic and SPE statistic (b) detection results of static T² statistic.

FIG. 4 Detection results of MLGSSM for fault 1 in R2S process.

FIG. 5 Detection results of MLGSSM for fault 2 in R2S process.

FIG. 6 Detection results of MFA model for fault 1 in R2S process.

FIG. 7 Detection results of MFA model for fault 2 in R2S process.

FIG. 8 Detection results of MR-PCA model for fault 1 in R2S process.

FIG. 9 Detection results of MR-PCA model for fault 2 in R2S process.

FIG. 10 Detection results of FA1 model for fault 1 in R2S process.

FIG. 11 Detection results of FA1 model for fault 2 in R2S process.

FIG. 12 Detection results of FA2 model for fault 1 in R2S process.

FIG. 13 Detection results of FA2 model for fault 2 in R2S process.

### DETAILED EMBODIMENTS

Taking the papermaking wastewater treatment process as an example, further elaboration on the present invention is provided:

A multi-rate process fault detection method based on a total auto-regressive dynamic latent variable model is proposed. This method addresses the fault detection issues in the papermaking wastewater treatment process. Firstly, various variables under normal working conditions are collected, including but not limited to the following variables: (1) The process variables obtained from the distributed control system, including equipment-level variables (such as current, voltage, power, displacement, rotation speed, etc., typically sampled at millisecond to second intervals) and process-level variables (such as temperature, pressure, flow rate, liquid level, etc., usually sampled at minute to hour intervals) (2) Quality-level data, which includes variables representing product yield and quality and is typically challenging to measure under normal operating conditions, can be obtained using analytical methods. These variables are often sampled at hourly to daily intervals. (3) Indicator-level data, representing operational and economic indicators such as efficiency and energy consumption, which require statistical calculations, can be sampled at weekly to monthly intervals.

Utilizing this data as the model training dataset, a Total Multi-rate Auto-regressive Dynamic Latent Variable Model is established, whose model structure is estimated using the EM algorithm. At the same time, fault detection control limits are obtained. Based on this foundation, sampling is conducted during the online papermaking wastewater treatment process to obtain multi-rate test samples. The established model structure is then used to estimate the dynamic latent variables and static latent variables of the test samples, constructing fault detection statistics. By comparing these statistics with the corresponding control limits, potential faults in the papermaking wastewater treatment process can be detected, achieving the ultimate goal of fault detection.

This invention presents a multi-rate process fault detection method based on a total auto-regressive dynamic latent variable model, including the following steps:

Step1: Collecting process variable data at different sampling rate during the normal operation of the papermaking wastewater treatment process using the Distributed Control System (DCS). Additionally, obtaining multi-rate normal data of critical quality variables that are difficult to measure using laboratory methods. It is also possible to acquire equipment-level variable data and/or indicator-level variable data as needed, forming the training dataset for modeling. Assuming that within the specified time period, samples from variables with M different sampling rate are collected and form a dataset Y, Y={Y₁; Y₂; . . . ; Yₘ; . . . ; Y_{M}}. Wherein the variables sample at m-th sampling rate represent as Yₘ. The number of samples corresponding to M different sampling rates are K₁, K₂, . . . , K_{M}, respectively:

$${Y}_{m} ∈ {R}^{{K}_{m} \times {G}_{m}} \qquad ( 1 )$$

$${Y}_{m} = \{ {y}_{m} ( 1 ) , {y}_{m} ( 2 ) , … , {y}_{m} ( i ) , … , {y}_{m} ( {K}_{m} ) \} , m = 1 , 2 , … , M ; i = 1 , 2 , … , {K}_{m}$$

where R represents the set of real numbers. In the M variety types of process variables and quality variables, Gₘ represents the number of variables under sampling rate m, Kₘ represents the number of samples under sampling rate m; yₘ(i) represents i-th sample of the variables under sampling rate m. Store this data in the historical database to form the training sample set for modeling purposes.

Step2: Standardization of the sample set Y involves subtracting the mean of each element in the sample set from its corresponding variable sample mean and then dividing it by the overall standard deviation of the corresponding variable sample set. This process ensures that the standardized elements fluctuate around zero, with positive values indicating above-average levels and negative values indicating below-average levels. Additionally, there exists a linear relationship between the standardized elements and the latent variables, leading to the following multi-rate dynamic latent variable model:

$$\{ \begin{matrix}x ( k ) = Az ( k - 1 ) + v ( k ) \\ {y}^{ξ} ( k ) = {C}^{ξ} ( k ) x ( k ) + {u}^{ξ} ( k )\end{matrix} \qquad ( 2 )$$

The whole training set contain M different sampling rate. y^{ξ}(k)=[yₖ₁^{T}, yₖ₂^{T}, . . . , y_{kE}^{T}]^{T} represent the variables collected at moment k. E represents the number of sampling rate types corresponding to the variables collected at that moment. The variable sample set for m-th sampling rate is represented by yₘ. Similarly, C^{ξ}(k)=[Cₖ₁^{T}, Cₖ₂^{T}, . . . , C_{kE}^{T}]^{T} represents the dynamic divergence matrix for the model at moment k. Cₘ represent the dynamic divergence matrix for the m-th sampling rate. u^{ξ}(k)=[uₖ₁^{T}, uₖ₂^{T}, . . . , u_{kE}^{T}]^{T} represents the measurement noise for the m-th sampling rate at moment k. uₘ represents the noise for the m-th sampling rate which follow the Gaussian distribution uₘ˜N(0, Ωₘ), m=1, 2, . . . , M. Where Ωₘ represents the variance for the m-th sampling rate.

To facilitate the handling of multi-rate data and the intuitive representation of subsequent formulas, sampling coefficients λ are introduced The representation of these sampling coefficients is as follows:

$$λ = [ \begin{matrix}{λ}_{11} & {λ}_{12} & … & {λ}_{1 M} \\ {λ}_{21} & {λ}_{22} & … & {λ}_{2 M} \\ ⋮ & ⋮ & ⋱ & ⋮ \\ {λ}_{K 1} & {λ}_{K 2} & … & {λ}_{KM}\end{matrix} ] \qquad ( 3 )$$

$${λ}_{k m} = \{ \begin{matrix}1 , & If the variable at m - th rate acquired at k \\ 0 , & If the variable at m - th rate not acquired at k\end{matrix}$$

Therefore, the values of C^{ξ}(k) are all derived from {C₁, C₂, . . . , C_{M}} and determined by the corresponding sampling coefficients λ at moment k, indicating whether the variables at that sampling rate are sampled. Similarly, the values of u^{ξ}(k) are derived from {u₁, u₂, . . . , u_{M}} and determined by the sampling coefficients λ at moment k. For example, in a system with three sampling rates (M=3) at moment k, if only the normal process variable sample values for the first sampling rate are collected, then λ=ₖ₁, λ+ₖ₂=0, λₖ₃=0, C^{ξ}(k)=C₁(k), u^{ξ}(k)=u₁(k). At that time the model structure is:

$$\{ \begin{matrix}x ( k ) = A z ( k - 1 ) + v ( k ) \\ {y}_{1} ( k ) = {C}_{1} ( k ) \times ( k ) + {u}_{1} ( k )\end{matrix}$$

When normal variable sample values for the first and third sampling rate are collected, and the corresponding sample values for the second sampling rate are not collected: λₖ₁=λₖ₃=1 and λₖ₂=0, C^{ξ}(k)=[C₁(k); C₃(k)], u^{ξ}(k)=[u₁(k); u₃(k)]. At that time the model structure is:

$$\{ \begin{matrix}x ( k ) = A z ( k - 1 ) + v ( k ) \\ [ \begin{matrix}{y}_{1} ( k ) \\ {y}_{3} ( k )\end{matrix} ] = [ \begin{matrix}{C}_{1} ( k ) \\ {C}_{3} ( k )\end{matrix} ] \times ( k ) + [ \begin{matrix}{u}_{1} ( k ) \\ {u}_{3} ( k )\end{matrix} ]\end{matrix}$$

wherein X∈R^{D} represents the dynamic latent variables of this model with a dimensionality of D, x(k) represents the dynamic latent variables of the model at the moment k, z(k−1)=[x^{T}(k−1)x^{T}(k−2) . . . x^{T}(k−L)^{T}]∈R^{DL×1} incorporate the dynamic latent variables of this model from the past L moment steps, L is the lag time. Its initial value z(L)=x^{T}(L)x^{T}(L−1) . . . x^{T}(1)]^{T} and z(L)˜N(μ_{L}, V_{L}). The expectation of z(L) is denoted as μ_{L}, and its variance is denoted as V_{L}. A∈R^{D×DL} represents the state transition matrix for the model's dynamic latent variables. v(k) represents the dynamic noise of the model at moment k and its variance is represented as Q with v(k)˜N(0, Q).

Building upon the constructed multi-scale dynamic latent variable model and considering the autocorrelation and cross-correlation in system data, the model can be extended to the following Total multi-rate auto-regressive dynamic latent variable model:

$$\{ \begin{matrix}x ( k ) = A z ( k - 1 ) + v ( k ) \\ {y}^{ξ} ( k ) = {C}^{ξ} ( k ) \times ( k ) + {Ψ}^{ξ} ( k ) {t}^{ξ} ( k ) + {w}^{ξ} ( k )\end{matrix} \qquad ( 4 )$$

In this model, x(k), A, z(k−1), v(k), y^{ξ}(k), C^{ξ}(k) are defined as before. The union of all static latent variables for different measurement scales is denoted as {t₁, t₂, . . . tₘ, . . . t_{M}}. Where tₘ∈R^{S}^{ₘ} represents the unique static latent variables for m-th sampling rate. Sₘ is the dimensionality of the static latent variables for m-th rate. t^{ξ}(k)=[t₁^{T}(k), t₂^{T}(k), . . . , t_{E}^{T}(k)]^{T} represents the static latent variables corresponding to multi-rate samples at moment k. E denotes the number of measurement scale types for the data collected at moment k. t^{ξ}(k) comes from {t₁, t₂, . . . , tₘ, . . . t_{M}} and depends on whether the corresponding variables {Y₁; Y₂; . . . ; Yₘ; . . . ; Y_{M}} are collected. Similarly, a sampling coefficient λ is introduced. The union of static divergence matrices is denoted as {Ψ₁, Ψ₂, . . . Ψₘ, . . . Ψ_{M}}. Where Ψₘ represents the static divergence matrix for m-th sampling rate. Ψ^{ξ}(k)=diag{Ψ₁^{T}(k), Ψ₂^{T}(k), . . . Ψ_{E}^{T}(k)} come from {Ψ₁, Ψ₂, . . . Ψₘ, . . . Ψ_{M}} and depend on the sampling coefficient λ. w^{ξ}(k) represents the measurement noise with w^{ξ}(k)=diag{w₁^{T}(k), w₂^{T}(k), . . . w_{E}^{T}(k)}. w^{ξ}(k) similarly come from {w₁, w₂, . . . wₘ, . . . w_{M}} wherein wₘ represents the measurement noise for the variables at m-th sampling rate. follows a Gaussian distribution wₘ˜N(0, Rₘ). Rₘ represents the static divergence matrix and the union of static divergence matrices is denoted as {R₁, R₂, . . . Rₘ, . . . R_{M}}. Similarly:

$${w}^{ξ} ( k ) ∼ N ( 0 , {R}^{ξ} ( k ) ) \\ {R}^{ξ} ( k ) = d iag \{ {R}_{1} ; {R}_{2} ; … ; {R}_{E} \}$$

Where R^{ξ}(k) come from {R₁, R₂, . . . Rₘ, . . . R_{M}} and depend on the sampling coefficient λ, same as C^{ξ}(k).

Step 3: Utilize the EM algorithm to update model parameters. In the E-step, combine the Kalman filtering algorithm with the Bayesian method using current model parameters to estimate the posterior probabilities (posterior expectations) of dynamic latent variables and static latent variables, respectively. In the M-step, update the parameters of the TMrARDLV by maximizing the likelihood function. Finally, iterate between the E-step and M-step until the model convergence condition is met. Firstly, randomly initialize the model parameters {Cₘ, Ψₘ, Rₘ, A, Q, μ_{L}, V_{L}}, (m=1, 2, . . . , M). Due to the requirements of the input data format for Kalman filtering, make appropriate transformations to the model. The transformed results are as follows:

$$\{ \begin{matrix}z ( k ) = \overline{A} z ( k - 1 ) + \overline{v} ( k ) \\ {y}^{ξ} ( k ) = {\overline{C}}^{ξ} ( k ) \times ( k ) + {Ψ}^{ξ} ( k ) {t}^{ξ} ( k ) + {w}^{ξ} ( k )\end{matrix} \qquad ( 5 )$$

where the extended dynamic latent variable at moment k is represented as z(k)=[x^{T}(k)x^{T}(k−1) . . . x^{T}(k−L)]^{T}∈R^{DL×1}. z(k) contain the value of past L moment and L is the lag time. Ā represents the transformed dynamic matrix after the conversion. v̅ₖ represents the transformed dynamic noise at moment k, with a variance of Q̅, following a specific distribution v̅ₖ˜N(0, Q̅). The specific transformation of model parameters is as follows:

$$\overline{A} = [ \begin{matrix}A & \\ I & 0\end{matrix} ] ∈ {R}^{D L \times D L} \qquad ( 6 )$$

$$\overline{Q} = [ \begin{matrix}Q & 0 \\ 0 & 0\end{matrix} ] ∈ {R}^{D L \times D L}$$

$${\overline{C}}^{ξ} ( k ) = \begin{matrix}[ {C}^{ξ} ( k ) & 0 ]\end{matrix}$$

I represent the identity matrix and 0 represents the zero matrix. The complete log-likelihood function for the model is as follows:

$$Θ = ln \{ \begin{matrix}{\prod }_{k = L + l}^{K} p ( x ( k ) \vert z ( k - 1 ) ) {\prod }_{k = 1}^{{K}_{1}} p ( {t}_{1} ( k ) ) … {\prod }_{k = 1}^{{K}_{M}} p ( {t}_{M} ( k ) ) \times \\ p ( z ( L ) ) {\prod }_{k = 1}^{K} p ( {y}^{ξ} ( k ) \vert \times ( k ) , {t}_{1} ( k ) , … , {t}_{E} ( k ) )\end{matrix} \} \qquad ( 8 )$$

$$= - {\sum }_{k = 1}^{K} ( \begin{matrix}- {\frac{1}{2} [ ( {y}^{ξ} ( k ) - {C}^{ξ} ( k ) \times ( k ) - {Ψ}^{ξ} ( k ) {t}^{ξ} ( k ) ) ]}^{T} \times \\ {( {R}^{ξ} ( k ) )}^{- 1} [ {y}^{ξ} ( k ) - {C}^{ξ} ( k ) \times ( k ) - {Ψ}^{ξ} ( k ) {t}^{ξ} ( k ) ]\end{matrix} )$$

$$- \frac{K}{2} ln \vert {R}_{m} \vert$$

$$- {\sum }_{k = L + 1}^{K} ( - \frac{1}{2} {( x ( k ) - A z ( k - 1 ) )}^{T} {Q}^{- 1} ( x ( k ) - A z ( k - 1 ) ) )$$

$$- \frac{K - L}{2} ln \vert Q \vert$$

$$- \frac{1}{2} {( z ( L ) - {μ}_{L} )}^{T} {V}_{L}^{- 1} ( z ( L ) - {μ}_{L} )$$

$$- \frac{1}{2} ln \vert {V}_{L} \vert + constant$$

Wherein Θ represent the value of the maximum likelihood function. Constant represents an arbitrary constant. p(●) represents the calculation of probability density. p(x(k)|z(k−1)) represents the probability density function of x(k) with respect to z(k−1). p(t₁(k)) represents the probability density function of the static latent variable for the first sampling rate, and so on. p(y^{ξ}(k)|x(k), t^{ξ}(k)) represents the probability density function of y^{ξ}(k) with respect to {x(k), t^{ξ}(k)}.

In the E-step of model parameter estimation, based on the current initial values of the model parameters, the updated values for estimating the dynamic latent variables are obtained using the Kalman filtering algorithm. The main formulas are as follows:

$$\hat{z} ( k \vert k - 1 ) = \overline{A} \hat{z} ( k - 1 \vert k - 1 ) \qquad ( 9 )$$

$$\hat{V} ( k \vert k - 1 ) = \overline{A} \hat{V} ( k - 1 \vert k - 1 ) {\overline{A}}^{T} + \overline{Q} \qquad ( 10 )$$

$${K}_{k} = \hat{V} ( k \vert k - 1 ) {{{\overline{C}}^{ξ} ( k )}^{T} [ {\overline{C}}^{ξ} ( k ) \hat{V} ( k \vert k - 1 ) {{\overline{C}}^{ξ} ( k )}^{T} + {Ψ}^{ξ} ( k ) {{Ψ}^{ξ} ( k )}^{T} + {R}^{ξ} ( k ) ]}^{- 1} \qquad ( 11 )$$

$$\hat{z} ( k \vert k ) = \hat{z} ( k \vert k - 1 ) + {K}_{k} [ y ( k ) - {\overline{C}}^{ξ} ( k ) \hat{z} ( k \vert k - 1 ) ] \qquad ( 12 )$$

$$\hat{V} ( k \vert k ) = \hat{V} ( k \vert k - 1 ) - {K}_{k} {\hat{C}}^{ξ} ( k ) \hat{V} ( k \vert k - 1 ) \qquad ( 13 )$$

Where \hat{z}(k|k−1) represents the estimation of the extended dynamic latent variables for the training samples at moment k, using the prediction results from moment k−1. \hat{z}(k−1|k−1) represents the optimal estimation of the extended dynamic latent variables for the training samples at moment k−1. \hat{z}(k|k) represents the optimal estimation of the extended dynamic latent variables for the training samples at moment k. \hat{V}(k|k−1) represents the covariance corresponding to \hat{z}(k|k−1). \hat{V}(k−1|k−1) represents the covariance corresponding to \hat{z}(k−1|k−1). \hat{V}(k|k) represents the covariance corresponding to \hat{z} (k|k). Kₖ represents the Kalman gain matrix. For convenience, let \hat{z} (k|k) be represented as \hat{z}(k) and let \hat{V}(k|k) be represented as \hat{V}(k).

Similarly, in the E-step, based on the current initial values of the model, the posterior expectations of static latent variables for each scale are estimated using the Bayesian method. First, the residuals between the observation variables and the reconstructed values obtained from the dynamic latent variables need to be calculated for the m-th sampling-rate at moment k:

$${f}_{m} ( k ) = {y}_{m} ( k ) - \overline{C} {z}_{m} ( k ) , ( m = 1 , 2 , … , M )$$

The posterior expectation of the static latent variable for the m-th rate is calculated based on the obtained residuals. The main formula is as follows:

$$E ( {t}_{m} ( k ) ) = {( {M}_{m} )}^{- 1} {Ψ}_{m}^{T} {y}_{m} ( k ) E ( {t}_{m} ( k ) {{t}_{m} ( k )}^{T} ) = {( {M}_{m} )}^{- 1} + E ( {t}_{m} ( k ) ) {E ( {t}_{m} ( k ) )}^{T}$$

Where E(●) represents the calculation of the expectation. Therefore, E(tₘ(k)) represents the posterior expectation of the unique static latent variable tₘ(k) at m-th sampling rate. E(tₘ(k)tₘ(k)^{T}) represents the variance corresponding to E(tₘ(k)). Wherein (Mₘ)⁻¹=[ΨₘΨₘ^{T}Rₘ⁻¹.]⁻¹.

Compare the differences between the log-likelihood values Θ_{new} corresponding to the new model parameters and the log-likelihood values corresponding Θ_{old} to the original model parameters. If ∥Θ_{new}−Θ_{old}∥²<ε, proceed to the step 4. Otherwise, continue iterating the EM algorithm, where ε is the threshold for model convergence.

In the M-step, based on the results from the E-step, calculate the partial derivatives of the log-likelihood function with respect to the model parameters to obtain the updated values Ĉₘ^{new}, \hat{Ψ}ₘ^{new}, \hat{R}ₘ^{new}, Â^{new}, \hat{Q}^{new}, \hat{μ}_{L}^{new}, \hat{V}_{L}^{new} for {Cₘ, Ψₘ, Rₘ, A, Q, μ_{L}, V_{L}}, (m=1, 2, . . . , M):

$${\hat{A}}^{new} = ( {\sum }_{k = L + 1}^{K} E ( \hat{x} ( k ) {\hat{z} ( k - 1 )}^{T} ) ) {( {\sum }_{k = L + 1}^{K} E ( \hat{z} ( k - 1 ) {\hat{z} ( k - 1 )}^{T} ) )}^{- 1} \qquad ( 14 )$$

$${\hat{Q}}^{n e w} = \frac{1}{K - L} ( {\sum }_{k = L + 1}^{K} E ( \hat{x} ( k ) {\hat{x} ( k )}^{T} ) - {\hat{A}}^{new} {\sum }_{k = L + 1}^{K} {E ( \hat{x} ( k ) {\hat{z} ( k - 1 )}^{T} )}^{T} ) \qquad ( 15 )$$

$${\hat{C}}_{m}^{n e w} = ( {\sum }_{k = 1}^{{K}_{m}} ( {y}_{m} ( k ) {E ( \hat{x} ( k ) )}^{T} - {Ψ}_{m} E ( {t}_{m} ( k ) ) {E ( \hat{x} ( k ) )}^{T} ) ) {( {\sum }_{k = 1}^{{K}_{m}} E ( \hat{x} ( k ) {\hat{x} ( k )}^{T} ) )}^{- 1} \qquad ( 16 )$$

$${\hat{Ψ}}_{m}^{n e w} = {[ {\sum }_{k = 1}^{{K}_{m}} ( {y}_{m} ( k ) {E ( {t}_{m} ( k ) )}^{T} - {\hat{C}}_{m} E ( \hat{x} ( k ) ) {E ( {t}_{m} ( k ) )}^{T} ) ] [ {\sum }_{k = 1}^{{K}_{m}} E ( {t}_{m} ( k ) {{t}_{m} ( k )}^{T} ) ]}^{- 1} \qquad ( 17 )$$

$${\hat{R}}_{m}^{n e w} = \frac{1}{{K}_{m}} {\sum }_{k = 1}^{{K}_{m}} ( {y}_{m} ( k ) {{y}_{m} ( k )}^{T} - {\hat{C}}_{m}^{new} E ( \hat{x} ( k ) ) {{y}_{m} ( k )}^{T} - {\hat{Ψ}}_{m}^{n e w} {E ( {t}_{m} ( k ) )}^{T} {{y}_{m} ( k )}^{T} ) \qquad ( 18 )$$

$${\hat{μ}}_{L}^{n e w} = \hat{z} ( L ) \qquad ( 19 )$$

$${\hat{V}}_{L}^{n e w} = \hat{V} ( L ) - \hat{z} ( L ) {\hat{z}}^{T} ( L ) \qquad ( 20 )$$

Where E(\hat{x}(k)) represents the posterior expectation of the dynamic latent variables. E(\hat{x}(k)) can be obtained from \hat{z}(k−1), which can be represented as \hat{z}(k−1)=[E(\hat{x}(k))^{T} E(\hat{x}(k−1))^{T} . . . E(\hat{x}(k−L+1))^{T}]. E(\hat{x}(k)\hat{x}(k)^{T}) represents the covariance corresponding to E(\hat{x}(k)). E(\hat{x}(k)\hat{z}(k−1)^{T}) represents the covariance corresponding to \hat{x}(k) and \hat{z}(k−1). E(\hat{z}(k−1)\hat{z}(k−1)^{T}) represents the covariance corresponding to \hat{z}(k−1).

K represents the total number of samples in this unified sample space, and Kₘ represents the actual number of samples for the m-th sampling rate.

Step 4: After the convergence of the model parameter estimation, the posterior expectations of the training set dynamic latent variables E(\hat{x}(k)) obtained according to the EM algorithm steps are used. Based on all sample values of dynamic latent variables in the training set, the covariance of each variable is calculated to construct a covariance matrix cov(\hat{x})=(1/K−1)E(\hat{x}(k))E(\hat{x}(k))^{T}. Then, the dynamic T² statistical quantity of the data, denoted as T_{d}², is calculated as follows:

$${T}_{d}^{2} ( k ) = {E ( \hat{x} ( k ) )}^{T} {( cov ( \hat{x} ) )}^{- 1} E ( \hat{x} ( k ) )$$

In the later stages of the actual monitoring process, the aforementioned formula is utilized to compute the dynamic T² statistics of online samples.

The control limits for the T_{d}² are estimated based on the χ_{α}² distribution and represented as follows:

$${T}_{d , lim}^{2} = {χ}_{α}^{2} ( D )$$

Where D represents the dimension of the dynamic latent variables.
the posterior expectations of the training set static latent variables at different sampling rates E (tₘ(k)), m=1, 2 . . . M; k=1, 2, . . . , Kₘ obtained according to the EM algorithm steps are used. Based on all sample values of static latent variables in the training set, the covariance of each variable is calculated to construct a covariance matrix cov(tₘ)=(1/Kₘ−1)E(\hat{t}(k))E(\hat{t}(k))^{T}. Then, the static T² statistical quantity of the data, denoted as Tₛ², is calculated as follows:

$${T}_{s , m}^{2} ( k ) = {E ( {t}_{m} ( k ) )}^{T} {( cov ( {t}_{m} ) )}^{- 1} E ( {t}_{m} ( k ) )$$

The estimation method for T_{s_lim}², the control limit of Tₛ², is as follows: Tₛ²˜g·χₕ², which means that Tₛ² follows χ² distribution, wherein:

$$\begin{matrix}gh = mean ( {T}_{s}^{2} ) \\ 2 {g}^{2} h = var ( {T}_{s}^{2} )\end{matrix}$$

wherein mean (●) represents mean calculation, var (●) represents variance calculation, χₕ² represents chi-square distribution, g and h represent the coefficients and degrees of freedom of the chi-square distribution, respectively; by using the above equation, g and h can be obtained, and then the control limits for the Tₛ² statistic can be calculated.

The SPE statistic can be constructed through the model's reconstruction error of the training dataset. First, calculate the model's reconstruction values, variance, and reconstruction error e(k) for the samples:

$$\begin{matrix}\tilde{μ} ( k ) = {\overline{C}}^{ξ} {E ( \hat{x} ( k ) )}^{T} + {\hat{Ψ}}^{ξ} {E ( {t}_{m} ( k ) )}^{T} \\ Φ ( k ) = {\overline{C}}^{ξ} ( k ) \hat{V} ( k \vert k - 1 ) {{\overline{C}}^{ξ} ( k )}^{T} + {Ψ}^{ξ} ( k ) {{Ψ}^{ξ} ( k )}^{T} + {R}^{ξ} ( k ) \\ e ( k ) = {y}^{ξ} ( k ) - \tilde{μ} ( k )\end{matrix}$$

Therefore, the SPE statistic can be calculated as follows:

$$S P E ( k ) = {e}^{T} ( k ) {Φ ( k )}^{- 1} e ( k )$$

The estimation method for SPEₗᵢₘ, the control limit of SPE, is as follows: SPE˜g·χₕ², which means that SPE follows χ² distribution, wherein:

$$gh = mean ( SPE )$$

$$2 {g}^{2} h = var ( SPE )$$

wherein mean (●) represents mean calculation, var (●) represents variance calculation, χₕ² represents chi-square distribution, g and h represent the coefficients and degrees of freedom of the chi-square distribution, respectively; by using the above equation, g and h can be obtained, and then the control limits for the SPE statistic can be calculated.

Step 5: Collect new process variable samples corresponding to the training sample set at from the papermaking wastewater treatment process online. The sampling interval is determined by the highest sampling rate of the variables (which can be equal to or greater than the highest sampling rate; in this embodiment, it is chosen to be equal). These samples form the test sample set, which is then standardized. The standardization in this step can use the same method as in the step 2. The sample sizes for these sets are K′₁, K′₂, . . . , K′ₘ:

$${Y}_{m , t e s t} ∈ {R}^{{K}_{m}^{′} \times {G}_{m}} , {Y}_{m , t e s t} = \{ {y}_{m , t e s t} ( 1 ) , {y}_{m , t e s t} ( 2 ) , … , {y}_{m , t e s t} ( {K}_{m}^{′} ) \} , m = 1 , 2 , … , M \qquad ( 21 )$$

Step 6: Use the TMrARDLV model and its model parameters {Cₘ, Ψₘ, Rₘ, A, Q, μ_{L}, V_{L}}, (m=1, 2, . . . , M) obtained from training, process the test samples. Utilize the Kalman filtering algorithm to compute the expected value of the dynamic latent variables \hat{z}ₜₑₛₜ(k) at moment k for the test samples.

$${\hat{z}}_{test} ( k \vert k - 1 ) = \overline{A} {\hat{z}}_{test} ( k - 1 \vert k - 1 ) \qquad ( 22 )$$

$${\hat{V}}_{test} ( k \vert k - 1 ) = \overline{C} {\hat{V}}_{test} ( k - 1 \vert k - 1 ) {\overline{C}}^{T} + \overline{Q} \qquad ( 23 )$$

$${K}_{test} ( k ) = {\hat{V}}_{test} ( k \vert k - 1 ) {{\overline{C}}^{ξ} ( k )}^{T} {( {\overline{C}}^{ξ} ( k ) {\hat{V}}_{test} ( k \vert k - 1 ) {{\overline{C}}^{ξ} ( k )}^{T} + {Ψ}^{ξ} ( k ) {{Ψ}^{ξ} ( k )}^{T} + {R}^{ξ} ( k ) )}^{- 1} \qquad ( 24 )$$

$${\hat{z}}_{test} ( k \vert k ) = {\hat{z}}_{test} ( k \vert k - 1 ) + {K}_{k}^{test} ( {y}_{test}^{ξ} ( k ) - {\overline{C}}^{ξ} ( k ) {\hat{z}}_{test} ( k \vert k - 1 ) ) \qquad ( 25 )$$

$${\hat{V}}_{test} ( k \vert k ) = {\hat{V}}_{test} ( k \vert k - 1 ) - {K}_{k}^{test} {\overline{C}}^{ξ} ( k ) {\hat{V}}_{test} ( k \vert k - 1 ) \qquad ( 26 )$$

Where C̅^{ξ}(k)=[C^{ξ}(k)0]. \hat{z}ₜₑₛₜ(k−1|k−1) represents the optimal prediction result of the test samples at moment k−1. żₜₑₛₜ(k|k−1) represents the estimation of the extended dynamic latent variables of the test samples at moment k by using the predicted results from moment k−1. \hat{z}ₜₑₛₜ(k|k) represents the estimation of the extended dynamic latent variables of the test samples at moment k. \hat{V}ₜₑₛₜ(k|k−1) represents the covariance corresponding to \hat{z}ₜₑₛₜ(k|k−1). \hat{V}ₜₑₛₜ(k−1|k−1) represents the covariance corresponding to \hat{z}ₜₑₛₜ(k−1|k−1). \hat{V}ₜₑₛₜ(k|k) represents the covariance corresponding to \hat{z}ₜₑₛₜ(k|k). Kₜₑₛₜ(k) represents the Kalman Gain matrix at the moment k for the test sample. For convenience, let \hat{z}ₜₑₛₜ(k|k) be represented as \hat{z}ₜₑₛₜ(k) and let \hat{V}ₜₑₛₜ(k|k) be represented as \hat{V}ₜₑₛₜ(k). Using the expected values of the dynamic latent variables \hat{x}ₜₑₛₜ(k) obtained through the Kalman filtering algorithm at moment k, compute the T_{d}² statistics for the samples at moment k:

$${T}_{d , t e s t}^{2} ( k ) = {\hat{x}}_{t e s t}^{T} ( k ) {( cov ( \hat{x} ) )}^{- 1} {\hat{x}}_{t e s t} ( k )$$

Where cov(\hat{x}) represents the covariance of the dynamic latent variables in the training set.

Compute the expected value of the dynamic latent variables t_{m,test}(k) for the m-th sampling rate at moment k using the Bayesian method:

$$\begin{matrix}{t}_{m , t e s t} ( k ) = {M}_{m}^{- 1} ( {y}_{m , t e s t} ( k ) - \overline{C} {z}_{t e s t} ( k ) ) \\ {M}_{m}^{- 1} = {[ {Ψ}_{m} {Ψ}_{m}^{T} + {R}_{m}^{- 1} ]}^{- 1}\end{matrix}$$

Calculate the statistics Tₛ² for the sample for the m-th sampling rate at moment k using the expected values of the dynamic latent variables

$${t}_{k , m}^{t e s t} :$$

$${T}_{s , m , t e s t}^{2} ( k ) = {t}_{m , t e s t}^{T} ( k ) {( cov ( {t}_{m} ) )}^{- 1} {t}_{m , t e s t} ( k )$$

Where cov(tₘ) represents the covariance of the static latent variables in the training set.

Based on the model reconstruction error, construct the SPE statistic. The reconstruction value and its variance are represented as follows:

$$\begin{matrix}{\tilde{μ}}_{t e s t} ( k ) = {\overline{C}}^{ξ} {{\hat{x}}_{t e s t} ( k )}^{T} - {Ψ}^{ξ} {E ( {\hat{t}}_{t e s t}^{ξ} ( k ) )}^{T} \\ {Φ}_{t e s t} ( k ) = {\overline{C}}^{ξ} ( k ) \hat{V} ( k \vert k - 1 ) {{\overline{C}}^{ξ} ( k )}^{T} + {Ψ}^{ξ} ( k ) {{Ψ}^{ξ} ( k )}^{T} + {R}^{ξ} ( k )\end{matrix}$$

Based on this, the model's reconstruction error and SPE statistic can be calculated:

$$\begin{matrix}{e}_{t e s t} ( k ) = {y}_{test}^{ξ} ( k ) - {\tilde{μ}}_{test} ( k ) \\ SP {E}_{t e s t} ( k ) = {e}_{t e s t}^{T} ( k ) {Φ}_{t e s t}^{- 1} ( k ) {e}_{t e s t} ( k\end{matrix}$$

Step 7, determine whether it exceeds the control limit obtained in Step 4, and obtain the online fault detection results of the papermaking wastewater treatment process: if it exceeds the control limit, it is determined that a fault has occurred; Otherwise, it is determined that the production process is normal.

### APPLICATION EXAMPLES

We utilized real data from the R2S anaerobic reactor in a papermaking wastewater treatment plant to further test the fault detection results of the proposed TMrARDLV model. The papermaking wastewater treatment process (WWTP) is a complex process. In this process, the WWTP transforms wastewater into another form that can be returned to the water cycle with minimal environmental impact or reused directly. WWTP typically include mixing tanks, clarifiers, regulating tanks, anaerobic reactors, circulation pipes, anoxic tanks, and biogas tanks, among other components. The papermaking wastewater treatment system first transfers impurities to the non-aqueous phase and removes large suspended solids, precipitates, and floating oils. Then, microbial anaerobic and aerobic reactions are used to biodegrade the wastewater. Finally, the wastewater is reused through secondary sedimentation tanks, sand filtration, ultrafiltration, and reverse osmosis. By adding microbiological products suitable for improving water quality, the production of sludge and the concentration of chemical oxygen demand are significantly reduced. Due to the complexity of operating conditions and the diversity of raw material variations, various faults often occur in the system.

Furthermore, the WWTP is also a multi-rate process, where different variables are measured at different sampling rate. In this context, there are two sampling rates for process variables: 1 hour and 2 hours intervals. However, variables related to quality, as well as output variables, are measured once every 24 hours since laboratory analyses are conducted only once daily. Table 1 provides descriptions of all variables in the R2S process. Output variables were not utilized in this experiment and, therefore, are not provided.

TABLE 1
All Input Variables in the R2S Process

| | |
|---|---|
| No. | Variable Name |

Table 1.1: Input Monitoring Variables Sampled Every Hour in the R2S
Anaerobic Treatment Process

| | |
|---|---|
| 1 | The influent flow rate of |
| | R2S-1 anaerobic reactor |
| 2 | The influent flow rate of |
| | R2S-2 anaerobic reactor |
| 3 | The riser level of R2S |

Table 1.2: Input Monitoring Variables Sampled Every 2 Hours in the
R2S Anaerobic Treatment Process

| | |
|---|---|
| 1 | The water inflow of R2S-1 |
| | anaerobic reactor |
| 2 | The water circulation of |
| | R2S-1 anaerobic reactor |
| 3 | The influent PH value of |
| | R2S-1 anaerobic reactor |
| 4 | The influent temperature of |
| | R2S-1 anaerobic reactor |
| 5 | The effluent PH value of |
| | R2S-1 anaerobic reactor |
| 6 | The effluent temperature of |
| | R2S-1 anaerobic reactor |
| 7 | The water inflow of R2S-2 |
| | anaerobic reactor |
| 8 | The water circulation of |
| | R2S-2 anaerobic reactor |
| 9 | The influent PH value of |
| | R2S-2 anaerobic reactor |
| 10 | The influent temperature of |
| | R2S-2 anaerobic reactor |
| 11 | The effluent PH value of |
| | R2S-2 anaerobic reactor |
| 12 | The effluent temperature of |
| | R2S-2 anaerobic reactor |

Table 1.2: Input Monitoring Variables Sampled Every 24 Hours in the
R2S Anaerobic Treatment Process

| | |
|---|---|
| 1 | The influent CODcr value of |
| | R2S-1 anaerobic reactor |
| 2 | The influent COD value of |
| | R2S-1 anaerobic reactor |
| 3 | The influent COD value of |
| | R2S-2 anaerobic reactor |
| 4 | The influent SS value of |
| | R2S-1 anaerobic reactor |
| 5 | The influent SS value of |
| | R2S-1 anaerobic reactor |
| 6 | The influent PH value of |
| | R2S-1 anaerobic reactor |
| 7 | The influent PH value of |
| | R2S-2 anaerobic reactor |
| 8 | |

### Example Results and Analysis

In this example section, a total of 18 typical process and quality variables from two R2S anaerobic reactors were selected for multi-rate process modeling and monitoring. Detailed descriptions of the variables can be found in Table 2.

TABLE 2
Variable Names Selected for the Example

| No. | Variable Name |
|---|---|
| 1 | The influent flow rate of |
| | R2S-1 anaerobic reactor |
| 2 | The influent flow rate of |
| | R2S-2 anaerobic reactor |
| 3 | The riser level of R2S |
| 4 | The water inflow of R2S-1 |
| | anaerobic reactor |
| 5 | The water circulation of |
| | R2S-1 anaerobic reactor |
| 6 | The influent PH value of |
| | R2S-1 anaerobic reactor |
| 7 | The effluent PH value of |
| | R2S-1 anaerobic reactor |
| 8 | The water inflow of R2S-2 |
| | anaerobic reactor |
| 9 | The water circulation of |
| | R2S-2 anaerobic reactor |
| 10 | The influent PH value of |
| | R2S-2 anaerobic reactor |
| 11 | The effluent PH value of |
| | R2S-2 anaerobic reactor |
| 12 | The influent CODcr value of |
| | R2S-1 anaerobic reactor |
| 13 | The influent COD value of |
| | R2S-1 anaerobic reactor |
| 14 | The influent COD value of |
| | R2S-2 anaerobic reactor |
| 15 | The influent SS value of |
| | R2S-1 anaerobic reactor |
| 16 | The influent SS value of |
| | R2S-1 anaerobic reactor |
| 17 | The influent PH value of |
| | R2S-1 anaerobic reactor |
| 18 | The influent PH value of |
| | R2S-2 anaerobic reactor |

It can be observed that the process has three sampling rates, denoted by M=3. Variables (1-3) are sampled every hour, and variables (4-11) are measured every 2 hours. Both these types of variables are collected using online hardware sensors. Additionally, variables (12-18) are quality-related variables, tested and recorded in the laboratory once every 24 hours. Utilizing variables (1-18) generated data over 78 days to construct the TMrARDLV model as proposed earlier. The entire process collected 1872 samples for variables (1-3), 936 samples for variables (4-11), and 78 samples for variables (12-18).

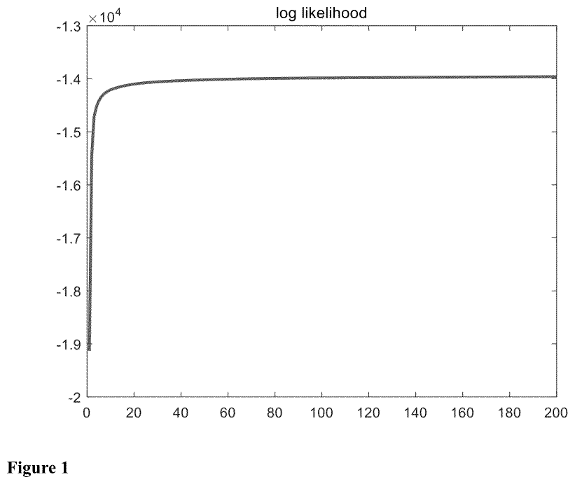

In the TMrARDLV model, the dynamic principal component dimension was set to 9, the static latent variable dimensions were set to 3 for each scale, the lag time length/, was set to 3, and the maximum iteration steps were set to 200. The likelihood function of the TMrARDLV model over iterations is shown in FIG. 1. It can be observed that the likelihood function continuously increased and gradually converged before reaching 200 steps.

To compare with the TMrARDLV model, the experiment selected the Multi-rate Linear Gaussian State Space Model (MLGSSM), Multi-rate Factor Analysis (MR-FA), Multi-rate Principal Component Analysis (MR-PCA), Factor Analysis 1 (FA1), and Factor Analysis 2 (FA2). FA₁ is a Factor Analysis model using down-sampling method, where all samples are reduced to the lowest sampling rate during the modeling process. FA2, on the other hand, only uses samples from the fastest sampling rate for modeling. The number of principal components for MLGSSM was also set to 9, while MR-FA and MR-PCA were set to 3. FA₁ and FA₂ had 3 and 2 principal components, respectively. The selection of these principal component numbers was based on cross-validation. To conduct fault detection, this example tested two types of faults collected from the actual operational process. After appropriate preprocessing, data from these two fault categories were extracted. Both types of faults contained 54 days of test data, with the faults occurring on the 20th day. Table 3 lists the false alarm rate and miss detection rate of different models for papermaking WWTP fault data at a significance level of 0.99. Fault 0 represents normal data in the online monitoring, and its corresponding result is the false alarm rate.

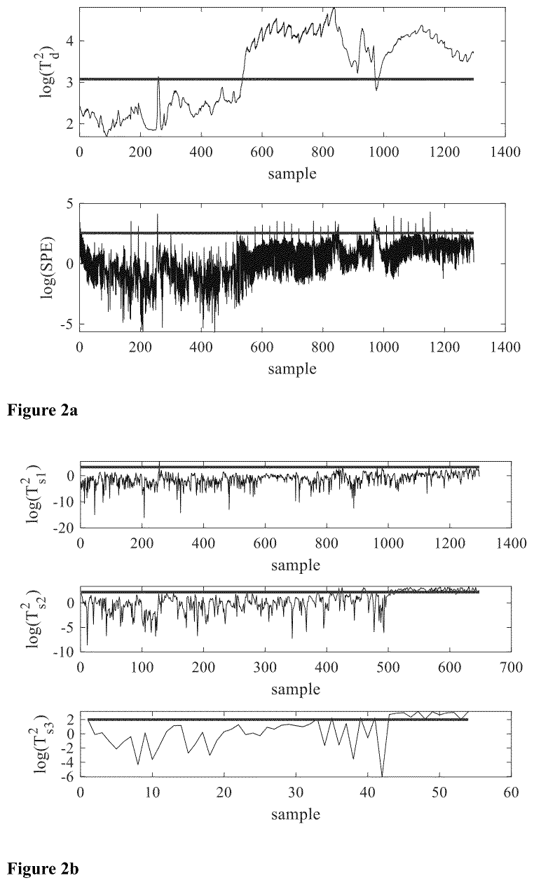

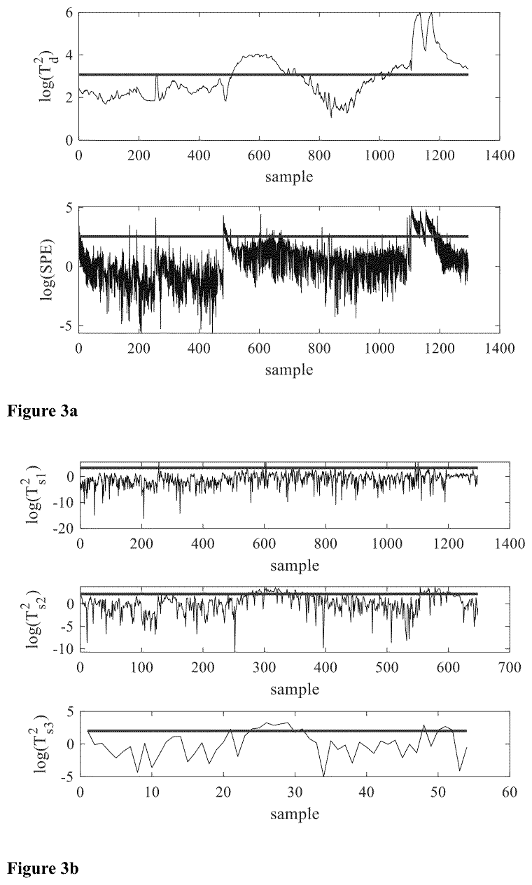

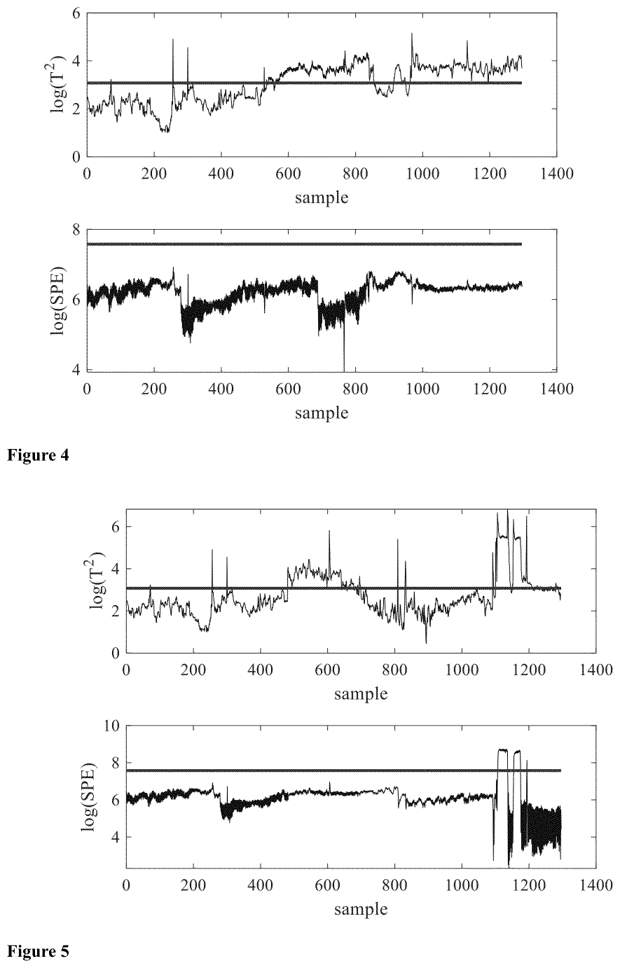

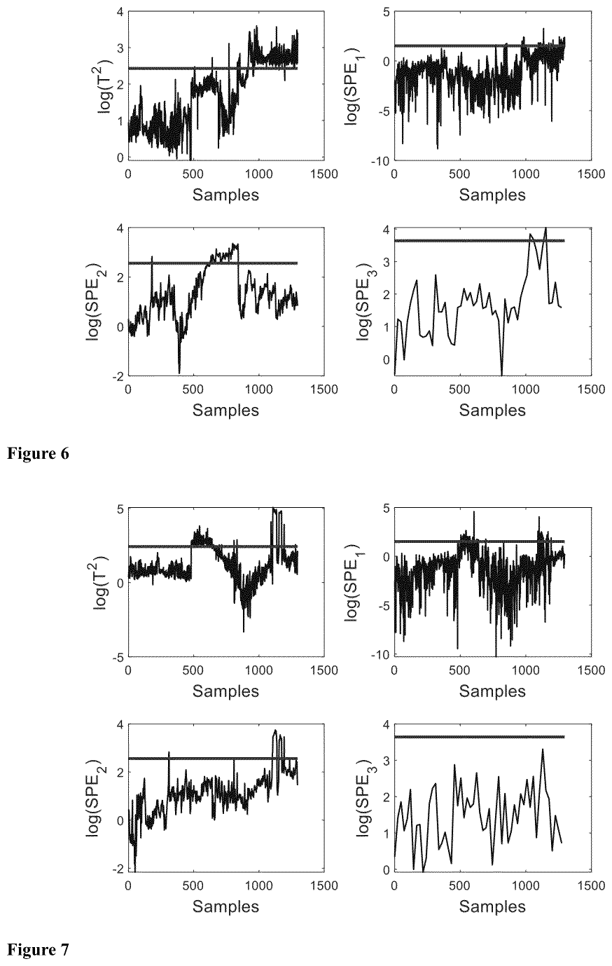

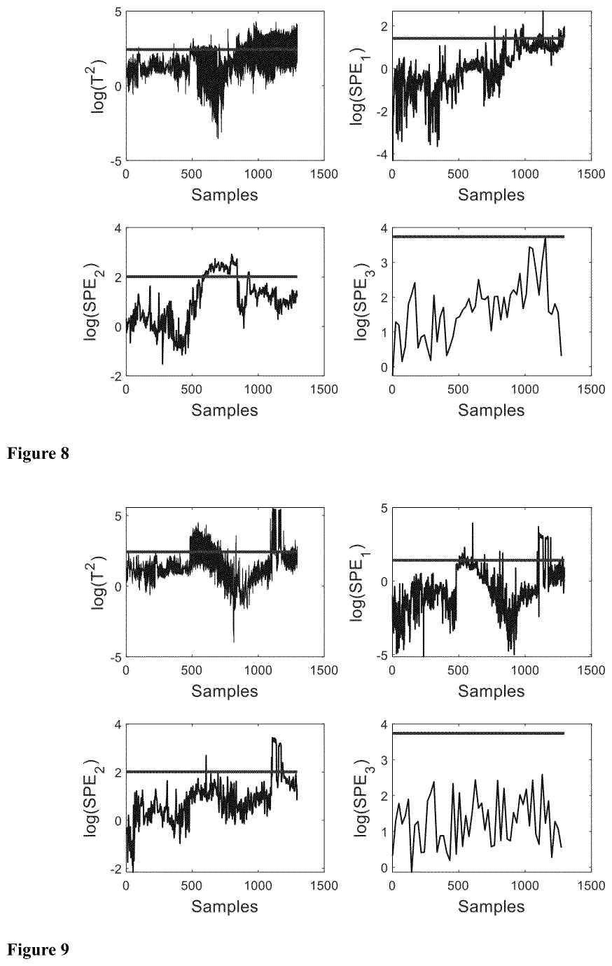

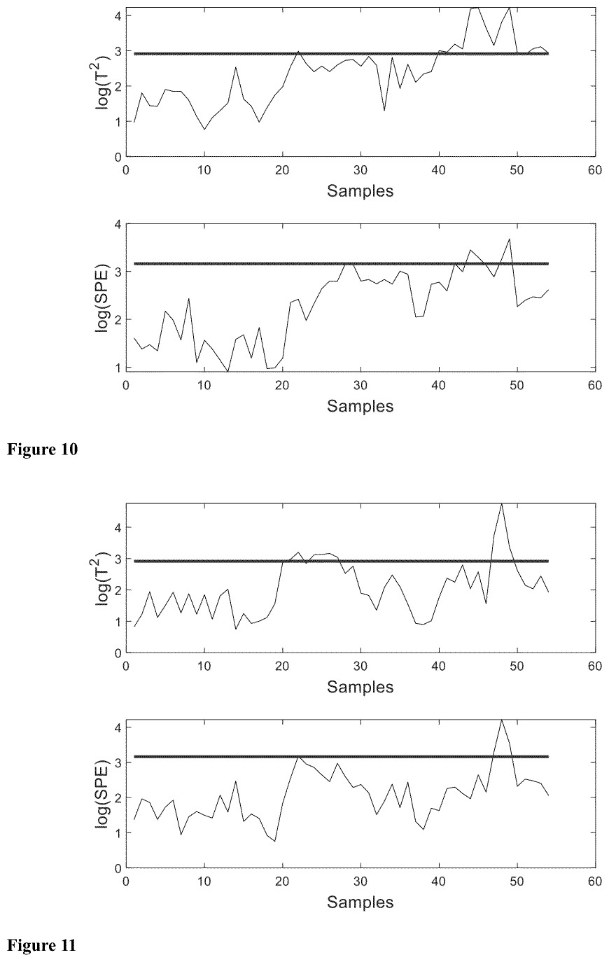

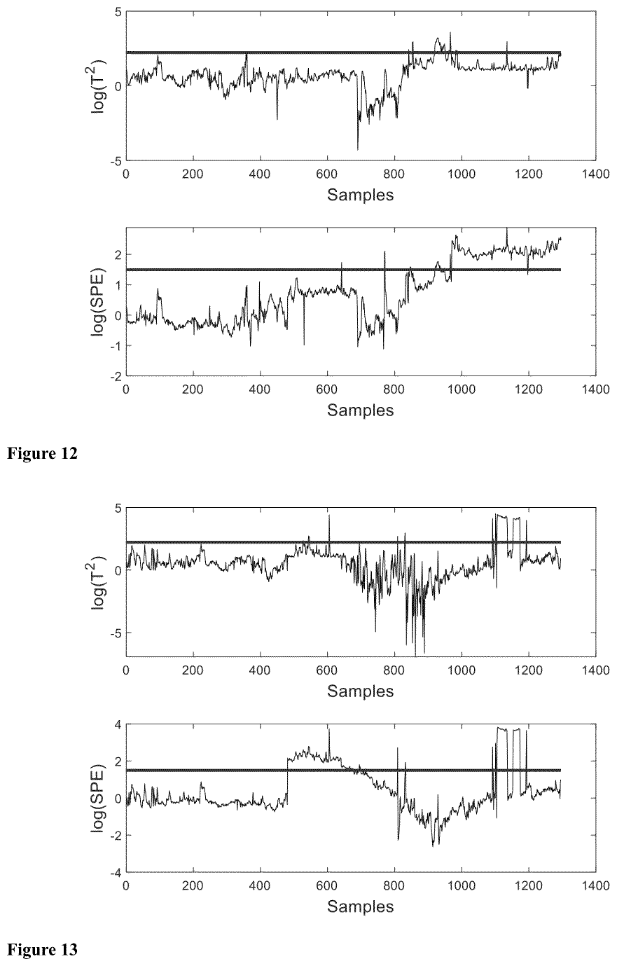

The example results of R2S process data validated the effectiveness and superiority of the proposed method. Achieving a low false alarm rate, the TMrARDLV method produced outstanding results, outperforming most comparative models. The fault detection results of the model are shown in FIGS. 2 to 13.

According to the example results, the TMrARDLV model proposed in this invention showed excellent performance in the fault detection task of papermaking wastewater treatment processes. While ensuring a low false alarm rate, the miss detection rate of the fault detection method based on the TMrARDLV model was the lowest, allowing timely response to most complex faults compared to the comparative methods. Compared to other comparative methods, the proposed fault detection method is designed with specific fault detection indicators tailored to different latent variable spaces in the papermaking wastewater treatment process. It can detect faults from various aspects in complex and coupled processes. Additionally, the proposed method is a high-order dynamic model, providing better robustness and accuracy in fault detection for highly time-correlated process data.

Table 3 presents the example results for papermaking wastewater treatment process data. F0 represents the ratio at which each model misclassifies normal samples as faults when online monitoring data are normal samples, which termed the false alarm rate. Due to the different structures of the models, different models have different numbers of fault detection indicators. However, they are generally divided into T² and SPE types of fault detection indicators. From the table, it can be seen that MLGSSM, FA₁, and FA₂ each designed only one T² and SPE statistic. However, MR-FA and MR-PCA, being multi-sampling rate (multi-rate) models, designed 72 statistics and multiple SPE statistics in the residual space at each sampling rate. In contrast, the TMrARDLV model proposed in this invention separately designed T² statistics for dynamic latent spaces and static latent spaces, thus having two types of T² statistics and one SPE statistic for process fault detection. F1 and F2 respectively represent the miss detection rate of different models when online monitoring data are fault samples of Fault 1 and Fault 2. The fault detection results for the two types of faults can evaluate the fault detection performance of different models.

TABLE 3
Example Results 1 of Papermaking WWTP Data

| | |
|---|---|
| MLGSSM | MR-FA |

| | T² | SPE | T² | SPE₁ | SPE₂ | SPE₃ |
|---|---|---|---|---|---|---|
| F0 | 0.000 | 0.000 | 0.000 | 0.000 | 0.008 | 0.006 |
| F1 | 0.167 | 0.988 | 0.531 | 0.924 | 0.735 | 0.912 |
| F2 | 0.584 | 0.946 | 0.713 | 0.914 | 0.921 | 1.000 |

Example Results 2 of Papermaking WWTP Data

| | MR-PCA | | | | FA₁ | | FA₂ | |
|---|---|---|---|---|---|---|---|---|
| | T² | SPE₁ | SPE₂ | SPE₃ | T² | SPE | T² | SPE |
| F0 | 0.000 | 0.000 | 0.000 | 0.000 | 0.038 | 0.026 | 0.009 | 0.003 |
| F1 | 0.588 | 0.925 | 0.674 | 1.000 | 0.559 | 0.853 | 0.942 | 0.565 |
| F2 | 0.748 | 0.885 | 0.992 | 1.000 | 0.735 | 0.882 | 0.914 | 0.670 |

Example Results 3 of Papermaking WWTP Data
TMrARDLV (The present invention method)

| | T²_{D} | SPE | T²_{S1} | T²_{S2} | T²_{S3} |
|---|---|---|---|---|---|
| F0 | 0.004 | 0.000 | 0.000 | 0.000 | 0.000 |
| F1 | 0.080 | 0.944 | 0.998 | 0.640 | 0.529 |
| F2 | 0.396 | 0.854 | 0.989 | 0.748 | 0.647 |

From the table, it can be observed that the proposed patent method, TMrARDLV, achieved the best results in different categories of statistics for different types of faults. The T² statistic for Fault 1 showed a 50% reduction in miss detection rate compared to the second-best method (MLGSSM). The miss detection rate for the SPE statistic also decreased correspondingly. For Fault 2, the performance of the patent method in both types of fault detection indicators showed significant improvement compared to the comparative methods. The optimal results for the same fault under the same indicator are highlighted in bold red.

1. A multi-rate process fault detection method based on a Total Auto-regressive Dynamic Latent Variable Model, the fault detection method comprising: collecting multi-rate data samples from chemical processes online, obtaining a test sample set, standardizing the test sample set, utilizing a Total Multi-rate Auto-regressive Dynamic Latent Variable model (TMrARDLV) to calculate the dynamic T² statistic, static T² statistics for each sampling rate, and SPE statistic for the current moment of the test sample, comparing them with pre-determined detection control limits to derive the online detection results for chemical processes. In the TMrARDLV, there exists a linear relationship between the multi-rate data samples and the dynamic latent variables as well as the static latent variables for each sampling rate.

2. According to the method for multi-rate process fault detection based on a Total Auto-regressive Dynamic Latent Variable Model as described in claim 1, it is characterized by comprising:
(I) For multi-rate processes, model training is conducted using the obtained multi-rate training sample set to derive a Total Auto-regressive Dynamic Latent Variable Model, as well as detection control limits for dynamic T² statistics, static T² statistics for each sampling rate, and SPE statistics.
(II) Online collection of new multi-rate process sample data corresponding to process variables and key quality variables of the training sample set in the evolving multi-rate process is performed to obtain a test sample set.
(III) The obtained test sample set is standardized in the same manner.
(IV) For the standardized test sample set, dynamic T² statistics for the current moment of the test sample, static T² statistics for each sampling rate, and SPE statistics are calculated using the derived TMrARDLV. The online detection results for the multi-rate process are determined by comparing these statistics with the obtained detection control limits.

3. According to the method for multi-rate process fault detection based on a Total Auto-regressive Dynamic Latent Variable Model as described in claim 1, it is characterized by the following: collecting a variety of multiple sampling rate variables under normal operating conditions of the chemical process, forming a training sample set for modeling, standardizing the training sample set, and then using it to construct the TMrARDLV.

4. According to the method for multi-rate process fault detection based on a Total Auto-regressive Dynamic Latent Variable Model as described in claim 1, it is characterized by the following: the structure of the TMrARDLV is as follows:
$$\{ \begin{matrix}x ( k ) = A z ( k - 1 ) + v ( k ) \\ {y}^{ξ} ( k ) = {C}^{ξ} ( k ) x ( k ) + {Ψ}^{ξ} ( k ) {t}^{ξ} ( k ) + {w}^{ξ} ( k )\end{matrix}$$
wherein: x(k) represents the dynamic latent variables of the model at moment k; z(k−1) contains the dynamic latent variables of the model at the past L moments, L is the lag time; A represents the state transition matrix of the dynamic latent variables of the model; v(k) represents the dynamic noise of the model at moment k; y^{ξ}(k) represents the variables collected at moment k; C^{ξ}(k) represents the dynamic divergence matrix between the variables collected at the moment k and the dynamic latent variables.; t^{ξ}(k) represents the static latent variables corresponding to the variables collected at moment k, Ψ^{ξ}(k) represents the static divergence matrix between the variables collected at moment k and the corresponding static latent variables.; w^{ξ}(k) represents the measurement noise of the variables collected at moment k; ξ represents the attributes of the samples collected at the current moment.

5. According to the method for multi-rate process fault detection based on a Total Auto-regressive Dynamic Latent Variable Model as described in claim 4, it is characterized by the following: incorporating sampling coefficients during both model training and practical use, the representation of the sampling coefficients is as follows:
$$\begin{matrix}λ = [ \begin{matrix}{λ}_{11} & {λ}_{12} & ⋯ & {λ}_{1 M} \\ {λ}_{21} & {λ}_{22} & ⋯ & {λ}_{2 M} \\ ⋮ & ⋮ & ⋱ & ⋮ \\ {λ}_{K 1} & {λ}_{K 2} & ⋯ & {λ}_{KM}\end{matrix} ] \\ {λ}_{km} = \{ \begin{matrix}1 , If the variable at m - th rate acquired at k \\ 0 , If the variable at m - th rate not acquired at k\end{matrix}\end{matrix}$$
In the structure of the TMrARDLV:
The value of y^{ξ}(k) comes from {y₁, y₂, . . . yₘ, . . . Y_{M}}, and its composition is determined by sampling coefficients, yₘ represents the sample set of variables at m-th sampling rate.
The value of C^{ξ}(k) comes from {C₁, C₂, . . . , Cₘ, . . . , C_{M}}, and its composition is determined by sampling coefficients, Cₘ represents the dynamic divergence matrix between variables and dynamic latent variables at m-th sampling rate.
The value of t^{ξ}(k) comes from {t₁, t₂, . . . tₘ, . . . t_{M}}, and its composition is determined by sampling coefficients, tₘ represents the unique static latent variable specific to variables at m-th sampling rate.
The value of Ψ^{ξ}(k) comes from {Ψ₁, Ψ₂, . . . Ψₘ, . . . Ψ_{M}}, and its composition is determined by sampling coefficients, Ψₘ represents the static divergence matrix for the m-th sampling rate.
The value of w^{ξ}(k) comes from {w₁, w₂, . . . wₘ, . . . w_{M}}, and its composition is determined by sampling coefficients, wₘ represents the measurement noise of variables at m-th sampling rate, which follows the Gaussian distribution wₘ˜N(0, Rₘ).

6. According to the method for multi-rate process fault detection based on a Total Auto-regressive Dynamic Latent Variable Model as described in claim 1, it is characterized by the following: the TMrARDLV is optimized by the Expectation-Maximization (EM) algorithm.

7. According to the method for multi-rate process fault detection based on a Total Auto-regressive Dynamic Latent Variable Model as described in claim 6, it is characterized by the following: during the optimization process using the EM algorithm, in the E-step, the posterior probabilities of dynamic and static latent variables are estimated using a combination of the Kalman filtering algorithm and Bayesian methods, based on the current model parameters. In the M-step, the parameters of the TMrARDLV are updated by maximizing the likelihood function. The E-step and M-step are iteratively performed until the model converges to the specified conditions.

8. According to the method for multi-rate process fault detection based on a Total Auto-regressive Dynamic Latent Variable Model as described in claim 1, it is characterized by the following: The control limits mentioned are directly obtained from the chi-square distribution, or derived from the corresponding statistics obtained from the training samples using the chi-square distribution. Alternatively, a combination of these two methods can be used to obtain the control limits.

9. According to the method for multi-rate process fault detection based on a Total Auto-regressive Dynamic Latent Variable Model as described in claim 8, it is characterized by the following: The detection control limits are obtained through the following methods:
Control limits T_{d,lim}² for dynamic T² statistic is estimated from the chi-square distribution χ_{α}² based on the dimensionality of dynamic latent variables. The control limits T_{s_lim}² for static T² statistics under each sampling rate are obtained from the static T² statistics of the training set under each sampling rate by using the chi-square distribution. The static T² statistics under each sampling rate are calculated from the posterior expectations of static latent variables for each rate and the covariance matrices of different static latent variables in the training set. The control limits for SPE (Squared Prediction Error) are obtained from the SPE statistics of the training set through the chi-square distribution. The SPE statistics are derived from the reconstruction errors of the training set samples.

10. According to the method for multi-rate process fault detection based on a Total Auto-regressive Dynamic Latent Variable Model as described in claim 1, it is characterized by the following: the multi-rate process described here pertains to the papermaking wastewater treatment process.
